(19) United States
(12) Patent Application Publication
(10) Pub. No.: US 2014/0209649 A1
(43) Pub. Date: Jul. 31, 2014

(54) INTERCHANGEABLE HOLDER

(71) Applicant: Theodore S. SCHUSTER, Brighton, MA (US)

(72) Inventor: Theodore S. SCHUSTER, Brighton, MA (US)

(21) Appl. No.: 14/045,621

(22) Filed: Oct. 3, 2013

Related U.S. Application Data
(60) Provisional application No. 61/757,055, filed on Jan. 25, 2013.

(51) Int. Cl. F16M 11/04; A24F 13/08

(52) U.S. Cl. CPC F16M 11/04; A24F 13/08
USPC 224/545; 248/121; 131/260

(57) ABSTRACT

An interchangeable holder system or apparatus that can be modified quickly, without tools, that provides a user with a plurality of safe and convenient means of holding an object, such as a cigar or a flashlight or a large object.

### CROSS-REFERENCE TO RELATED APPLICATIONS

This application claims priority under 35 USC 119(e) to U.S. Provisional Application Ser. No. 61/757,055, (Attorney Docket No.: ITS-010PRV) filed on Jan. 25, 2013, titled INTERCHANGEABLE HOLDER, the entire disclosures of which are incorporated herein by reference.

### BACKGROUND

The present invention is related to holding apparatus and, more specifically, to an apparatus that holds objects, such as cigars, and utilizes interchangeable parts.

Good cigars are often expensive and rare. They are enjoyed by smokers in a variety of settings while participating in various activities. As a result, smokers invest in cigar holders to prevent damage to their cigars while also providing a safe and convenient method for holding a cigar as determined by the smoker's situation.

There are many types of cigar holders available today. Typically each type of cigar holder is static and therefore designed to fulfill a limited or unique need as determined by the situation. Several examples of single-purpose cigar holders exist within the world of golf. For safety and sanitary purposes, golfing-specific cigar holders are commonly used by golfers that smoke since placing a cigar on the ground or the grass of a golf course exposes the smoker to the hostile chemicals, poisons, fertilizers, and animal excrement deposited thereupon. One such example is a clamp-like device, where one end of the device holds the cigar while the other end of the device is attached to a golf cart. Another example is a stake-like device where one end of the device is driven into the ground while the top of the device supports the cigar above the golf course. An example of a limited purpose cigar holder outside of the golfing world is a portable, single-cigar stand that is used to hold a lit cigar when an ash tray is not available. The list of single-purpose cigar holders goes on. Since the designs of many cigar holders are limited to addressing specific needs, a cigar smoker may be forced to purchase a variety of holders which can be expensive and inconvenient.

Therefore what is needed is a universal holder that can be used in a variety of circumstances.

### SUMMARY

According to the various aspects of the present invention, a holder is provided within a system that is capable of holding an object, such as a cigar, in a variety of circumstances.

In accordance with various aspects of the present invention a holder system is disclosed. The holder system includes parts that can be interchanged by a user depending on which variation of the system best suits the user's need at such time.

The system includes a universal “V” shaped metal cradle that holds an object, such as a cigar, and interchangeable bases that support the cradle. In accordance with the various aspects of the present invention, interchangeability is accomplished by connecting a threaded stem that has been integrated into the bottom end of the cradle, to a matching threaded bore that has been incorporated in a variety of user-selected interchangeable bases.

Interchangeable bases include a plurality of designs and may include a magnetic base, a tabletop base, a tabletop base with integrated ash tray, a base that is shaped to fit within the cup holder of an automobile, a base with an integrated releasable clamp to grasp various supporting structures, and a base that is comprised of a stake or spike to be driven into the ground.

### BRIEF DESCRIPTION OF THE DRAWINGS

The specification disclosed includes the figures, wherein like numbers in the figures represent like numbers in the description and the figures are represented as follows:

FIG. 1 shows a cradle in accordance with the teachings of the present invention.

FIG. 1A shows an exploded view of the cradle of FIG. 1 in accordance with the teachings of the present invention.

FIG. 2 shows a magnetic base for receiving the cradle of FIG. 1 in accordance with the teachings of the present invention.

FIG. 3A shows an exploded view of the cradle of FIG. 1 and the magnetic base of FIG. 2 in accordance with the teachings of the present invention.

FIG. 3B shows a system with the cradle of FIG. 1 secured to a magnetic base of FIG. 2 in accordance with the teachings of the present invention.

FIG. 4 show a system with the cradle of FIG. 1 secured to a tabletop base in accordance with the teachings of the present invention.

FIG. 5 shows a system with the cradle of FIG. 1 attached to a base that is shaped to fit within a cup holder in accordance with the teachings of the present invention.

FIG. 5A shows an exploded view of the system of FIG. 5 in accordance with the teachings of the present invention.

FIG. 6 is a perspective view of the cradle of FIG. 1 secured to a base designed as an ash tray in accordance with the teachings of the present invention.

FIG. 7 shows a system with the cradle of FIG. 1 secured to a clamping device in accordance with the teachings of the present invention.

FIG. 7A shows an exploded view of the system of FIG. 7 in accordance with the teachings of the present invention.

FIG. 8 shows a single probe support base for receiving the cradle of FIG. 1 in accordance with the teachings of the present invention.

FIG. 8A shows an exploded view of the single probe support base of FIG. 8 in accordance with the teachings of the present invention.

FIG. 9 shows a dual probe support base for receiving the cradle of FIG. 1 in accordance with the teachings of the present invention.

FIG. 9A shows an exploded view of the dual probe support base of FIG. 9 in accordance with the teachings of the present invention.

FIG. 10 shows a system with the cradle of FIG. 1 secured to the support base of FIG. 9 in accordance with the teachings of the present invention.

FIG. 10A shows an exploded view of the system of FIG. 10 in accordance with the teachings of the present invention.

### DETAILED DESCRIPTION

Throughout the specification and claims, the following terms take at least the meanings explicitly associated herein unless the context dictates otherwise. The meanings identified below do not necessarily limit the terms, but merely provide illustrative examples for the terms. The meaning of “a” “an” and “the” includes plural reference, and the meaning of “in” includes “in” and “on.” The phrase “in one embodiment,” as used herein does not necessarily refer to the same embodiment, although it may. The phrase “in one aspect” or “in accordance with one aspect” or “in another aspect” as used herein does not necessarily refer to the same aspect, although it may. The phrase “in one embodiment” or “in accordance with another embodiment” as used herein does not necessarily refer to the same embodiment, although it may. As used herein, the term “or” is an inclusive “or” operator, and is equivalent to the term “and/or,” unless the context clearly dictates otherwise. The term “based, in part, on”, “based, at least in part, on”, or “based on” is not exclusive and allows for being based on additional factors not described, unless the context clearly dictates otherwise. The term “coupled” means at least either a direct connection between the items being connected, or an indirect connection through one or more passive or active intermediary devices or components. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Various aspects of the present invention are incorporated in the disclosed embodiments of the present invention. The aspects, as shown in the embodiments, will be described in detail with reference to the drawings, where like reference numerals represent like parts and assemblies throughout the several views. Reference to various embodiments does not limit the scope of the invention, which is limited only by the scope of the claims attached hereto. Additionally, the aspects of the present invention, as shown in any examples set forth in this specification, are not intended to be limiting and merely set forth some of the many possible embodiments for the claimed invention.

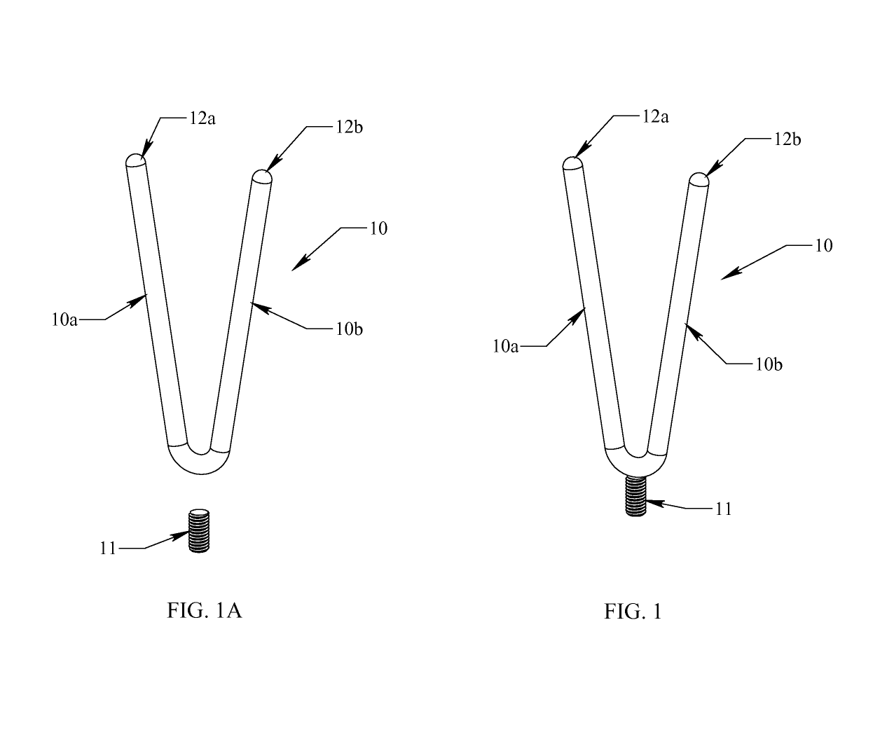

Referring now to FIG. 1 and FIG. 1A, a cradle 10 is shown that includes two arms 10a and 10b. The cradle 10 is roughly V-shaped and includes an outwardly projecting stem 11 at the bottom of the cradle 10. The shape of the cradle is not intended as a limitation and various other shapes can be considered within the scope of the present invention. The arms 10a and 10b of the cradle 10 become increasingly close to each other, from top to bottom, until eventually joining at the bottom of the V. Objects of various sizes, such as a flashlight or a cigar, are held in place between the arms 10a and 10b of the cradle 10 with pressure by lightly pressing the object downward, into the cradle 10. The arms 10a and 10b of the cradle are cylindrically shaped so that the object is not damaged while it is held in place between the arms 10a and 10b.

In accordance with one aspect of the present invention, top ends 12a and 12b of the arms 10a and 10b, respectively, are tapered from the inside towards the outside, such that the diameter at the distal ends of the arms 10a and 10b become smaller. In accordance with another aspect of the present invention, the diameter of the arms 10a and 10b is unchanged. The ends 12a and 12b of the arms 10a and 10b, respectively, are rounded at the distal tips to avoid accidentally piercing or damaging the object on one of the tips when an object is being placed in the cradle 10.

In accordance with one aspect of the present invention, each arm, such as arms 10a and 10b, is approximately three inches long making it easy to transport in a pocket or small bag. The distance between the distal ends 12a and 12b can range from 0.5 inches to 4 feet, including about 1 inch, which can accommodate large diameter objects. The diameter of the arms 10a and 10b can range from 0.1 inches to 6 inches including about 0.2 inches, which is sufficiently wide to securely hold larger objects and yet small enough to be easily transportable by the user. The scope of the present invention is not limited by the length/distance between or the diameter of the arms 10a and 10b. Furthermore, the length and diameter are provided as an example and not intended as a limitation. In accordance with the various aspects of the present invention, the stem 11 is proportional to the size of the cradle 10. Thus, the diameter of the stem 11 will correspond to the diameter of the cradle 10, which are both based on the size and weight of the object intended to be held by the cradle 10. In accordance with another aspect of the present invention and other embodiments, the stem 11 includes and defines a female portion of notch or similar groove (not shown) at the end of the stem 11, which is to be connected to or secured to the cradle 10. The cradle 10 would also include a corresponding and matingly similar male portion to the female portion of the groove, such that when the cradle 10 and the stem 11 are brought together, they are paired to each other and then connected or secured.

For example, the cradle 10 may be secured to a base that is mounted on a vehicle. In this case, the cradle would be large enough to hold a large object, such as a tree or a pipe, to allow the user to securely hold and cut or work with the large object.

In accordance with one aspect of the present invention, the stem 11 is integrated to the bottom of arms 10 by metalworking such as welding, brazing or soldering so as to create durability and reliability.

In accordance with one aspect of the present invention, the stem 11 of the cradle 10 is fastened to a base by turning the stem 11 in a clock-wise direction so that the stem 11 moves downwardly, into a bore defined by a base, as disclosed herein.

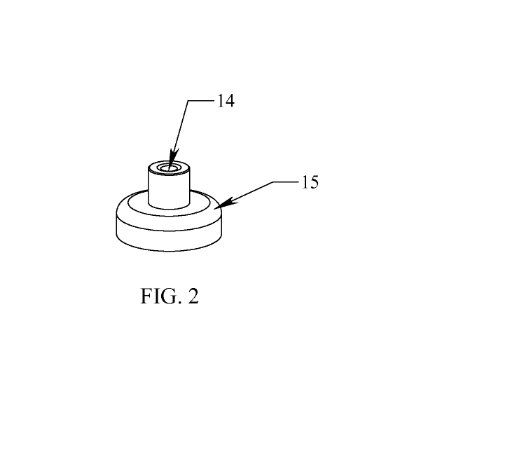

Referring now to FIG. 2, a mounting base 15 is shown. In accordance with one aspect of the present invention, the base 15 includes a bore 14 that is capable of receiving the stem 11 of FIG. 1 to secure the cradle 10 to the base 15 and create a system for holding an object. In accordance with one aspect of the present invention, the base 15 is magnetic to allow securing the system to a metal surface. In accordance with one aspect of the present invention, the base 15 is made of a non-magnetic material.

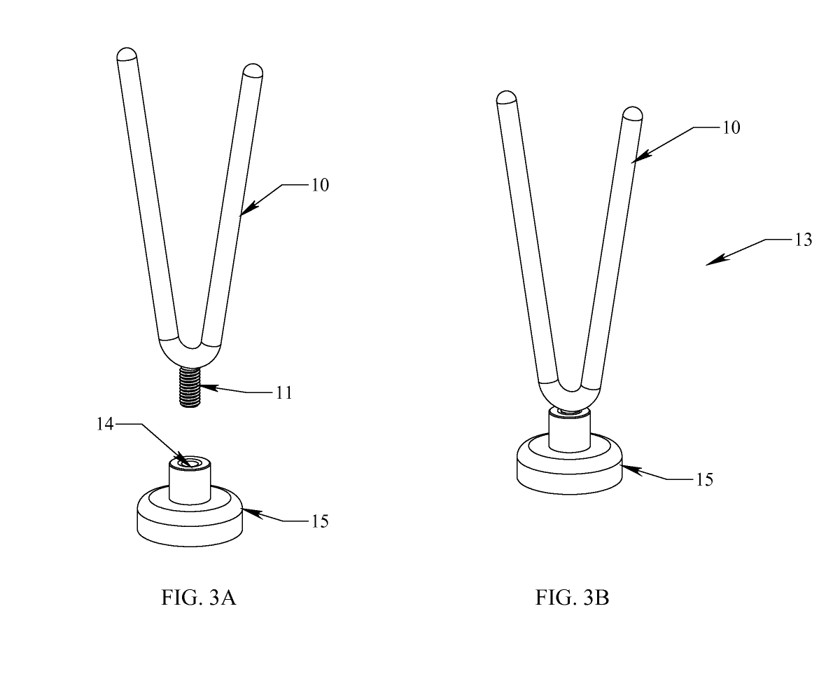

Referring now to FIGS. 3A and 3B, a system 13 is shown that includes the cradle 10 and base 15 of FIG. 2. In accordance with one aspect of the present invention, the cradle 10 is secured to the base 15 by inserting the stem 11, located at the bottom of the cradle 10, into the bore 14 that is defined by the base 15. In accordance with one aspect of the present invention, the length of the stem 11 is approximately 0.4 inches and the diameter is approximately 0.2 inches, which corresponds to the dimensions of the bore 14. It will be apparent that the scope of the present invention is not limited by the length or diameter of the stem 11. The stem 11 is sufficiently long and wide to create a secure connection to the base 15, yet short enough to conceal the entire stem 11 within the bore 14 of the base 15 so as to avoid interrupting the aesthetics of the system 13. In accordance with other aspects of the present invention, the stem 11 may be longer and exposed. For example, a longer stem will prevent contact between the cradle 10 and the respective base.

The scope of the present invention is not limited by the type of material used for the system 13. In accordance with one aspect of the present invention, the stem 11, cradle arms 10a and 10b, and base 15 may be made of the same material such as steel or another type of heat or fire-resistant material. The color, texture and decorative aspects of the system 13 may vary. In accordance with one aspect of the present invention, the stem 11 of the cradle 10 is fastened to the base 15 by turning the stem 11 in a clock-wise direction so that the stem 11 moves downwardly, into the bore 14.

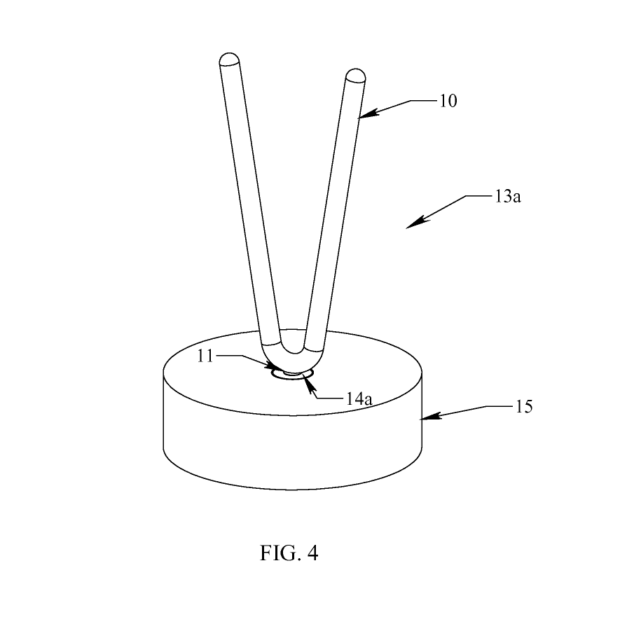

Referring now to FIG. 4, a system 13a is shown in accordance with one aspect of the present invention. The system 13a includes a bore 14a at a location that is consistent with the desired function and aesthetics of the related base 15. In accordance with one aspect of the present invention, the bore 14a may be embedded within the base 15 so that it is flush with the top side of the base 15 that is intended to rest on a flat surface. In accordance with one aspect of the present invention, the bore 14 may be attached within a cylindrically shaped protuberance from the top of a stake-style base or magnetic base 15 as seen in FIGS. 3A and 3B. Thus, it will be apparent to one skilled in the art that the scope of the present invention is not limited by the functional location of the bore relative to the base, except for as claimed herein.

The method of incorporating the bore to the base may also vary based upon considerations such as the function, aesthetics and composition of the interchangeable base. For example, if the base is made using a material that can be deformed with pressure, such as hardened rubber, then the bore may be embedded within a recess in the top side of the stand where the depth of the recess is roughly equal to the length of the bore, and the diameter of the recess is slightly smaller than the bore so that the bore will remain in place when pressed into the recess during the manufacturing process. In the case of the stake-style base and magnetic base, the bore may be embedded within the cylindrical protuberance by metalworking and the cylindrical protuberance may be attached to the stake and magnet also by metalworking. Thus, it will be apparent to one skilled in the art that the scope of the present invention is not limited by the method of attaching a bore to a base, except for as claimed herein.

In accordance with one aspect of the present invention, the stem 11 of the cradle 10 is fastened to a base by turning the threaded stem 11 in a clock-wise direction so that the stem 11 moves downwardly, into the bore 14a until the stem 11 is thumb-tight inside the bore 14a. In accordance with one aspect of the present invention, the stem 11 of the cradle 10 is fastened to or screwed into the base 15 by turning the stem 11 in a clock-wise direction so that the stem 11 moves downwardly, into the bore 14a.

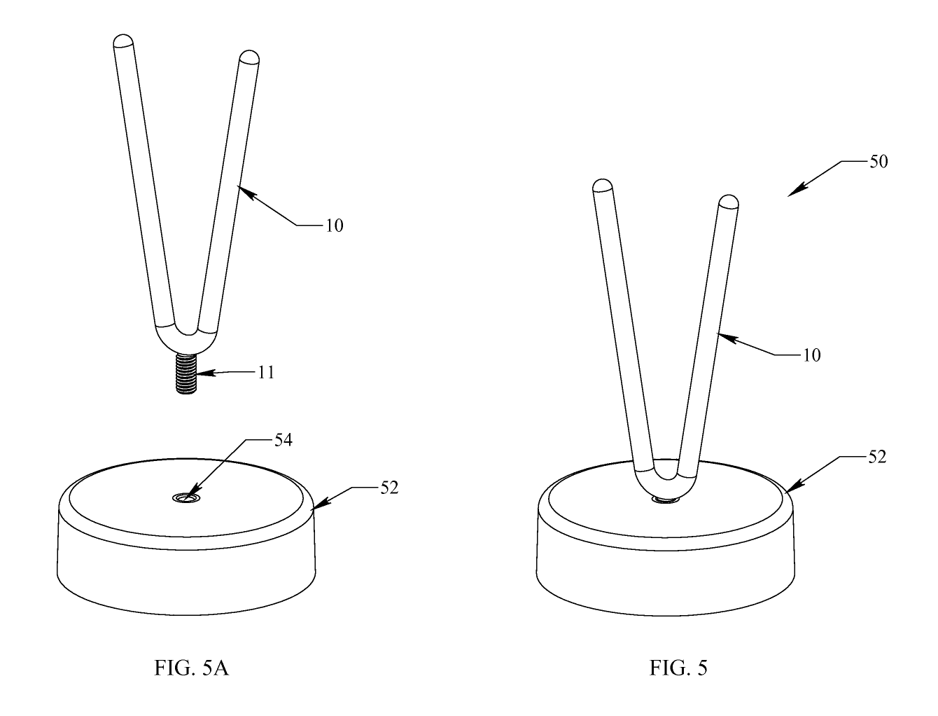

Referring now to FIG. 5 and FIG. 5A, in accordance with one aspect of the present invention, a system 50 is shown that includes the cradle 10 secured to a base 52. The cradle 10 is secured to the base 52 using the stem 11. The base 52 defines a bore 54 that receives the stem 11. In accordance with one aspect of the present invention, the stem 11 of the cradle 10 is fastened to or screwed into the base 52 by turning the stem 11 in a clock-wise direction so that the stem 11 moves downwardly, into the bore 54.

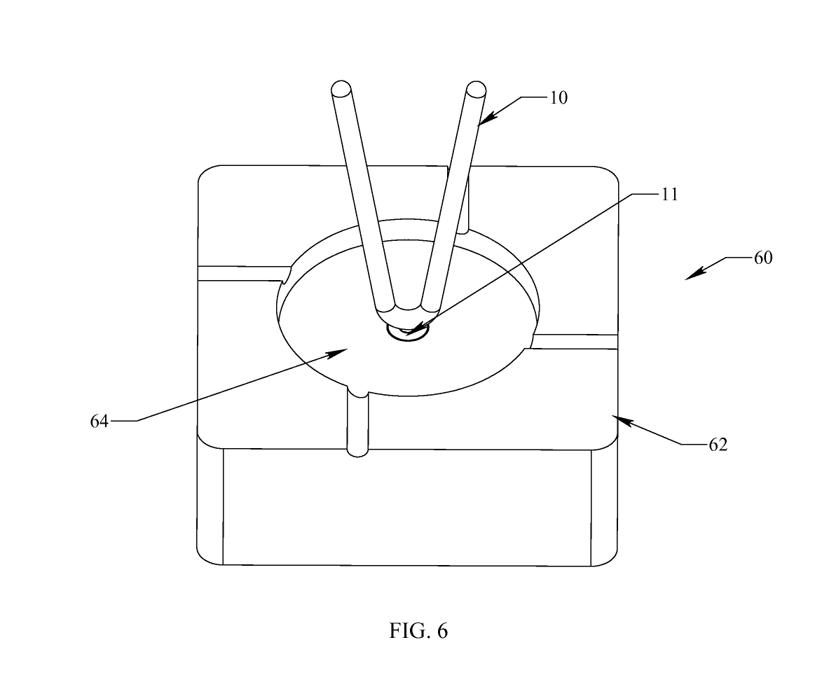

Referring now to FIG. 6, in accordance with one aspect of the present invention, a system 60 is shown. The system 60 includes the cradle 10 secured to an ash tray 62 using the stem 11 in a bore 64 defined by the ash tray 62. As indicated above, the cradle 10 may be removed by unscrewing the cradle 10 from the ash tray 62. In accordance with one aspect of the present invention, the stem 11 of the cradle 10 is fastened to or screwed into the ash tray 62 by turning the stem 11 in a clock-wise direction so that the stem 11 moves downwardly, into the bore 64.

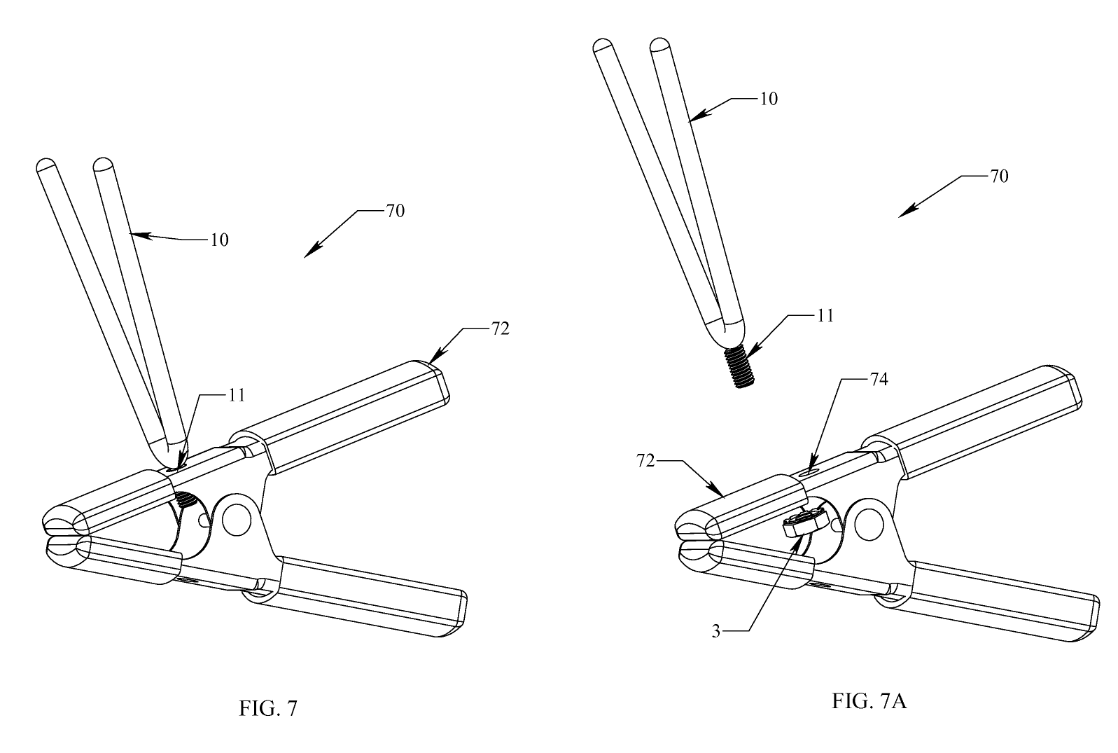

Referring now to FIG. 7 and FIG. 7A, in accordance with one aspect of the present invention, a system 70 is shown. The system 70 includes the cradle 10 and a holder 72. The holder 72 is a clamp type apparatus that defines a hole 74. The hole 74 receives the stem 11 of the cradle 10 and the cradle is secured in place to the holder 72 using a fastener or nut 73. As shown, the nut 73 includes a toothed washer, however any type of nut and washer system can be utilized and is considered within the scope of the present invention. In accordance with one aspect of the present invention, the stem 11 of the cradle 10 is fastened to or screwed into the holder 72 using the nut 73 by turning the stem 11 in a clock-wise direction so that the stem 11 moves downwardly, into the hole 72.

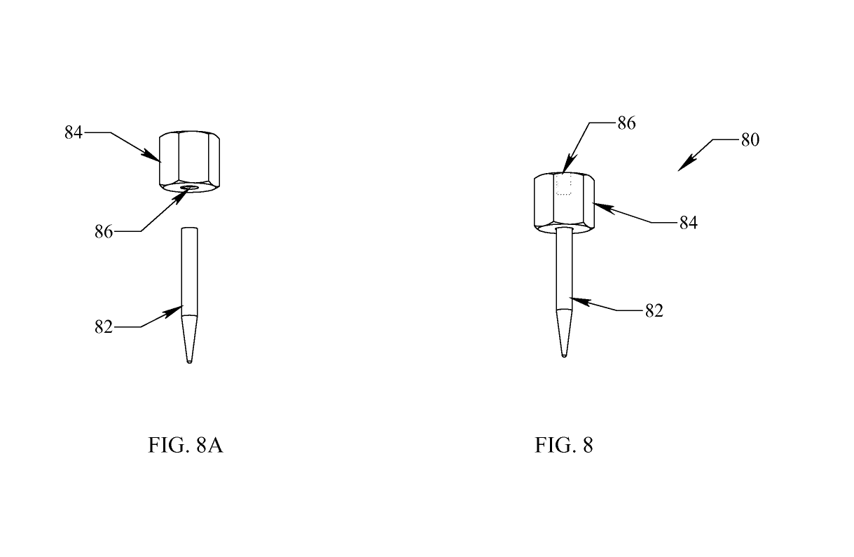

Referring now to FIG. 8 and FIG. 8A, in accordance with one aspect of the present invention, a base system 80 is shown. The base system 80 includes a spike or probe 82 and a base 84. The base 84 defines a bore 86 for receiving the stem 11 of the cradle 10 (not shown in this figure). The spike 82 is secured to the base 84 at a bore 88 defined by the base 84. In accordance with one aspect of the present invention, the probe 82 can be screwed or pressed into the bore 88, thereby allowing the spike 82 to be removable. In accordance with other aspects of the present invention, the probe 82 is permanently secured in the bore 88 of the base 84 through metalworking such as welding, brazing or soldering as well as any other means of creating a permanent attachment.

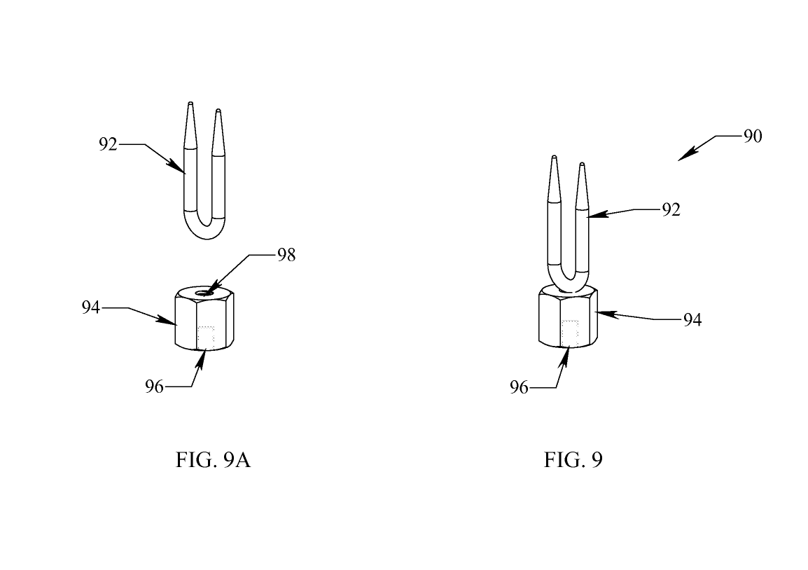

Referring now to FIG. 9 and FIG. 9A, in accordance with one aspect of the present invention, a base system 90 is shown. The base system 90 includes a spike or probe 92 and a base 94. The base 94 defines a bore 96 for receiving the stem 11 of the cradle 10 (not shown in this figure). The spike 92 is secured to the base 94 at a bore 98 defined by the base 94. In accordance with one aspect of the present invention, the probe 92 can be screwed or pressed into the bore 98, thereby allowing the spike 92 to be removably attached to the base 94. In accordance with other aspects of the present invention, the probe 92 is permanently secured to the base 94 through metalworking such as welding, brazing or soldering as well as any other means of creating a permanent attachment.

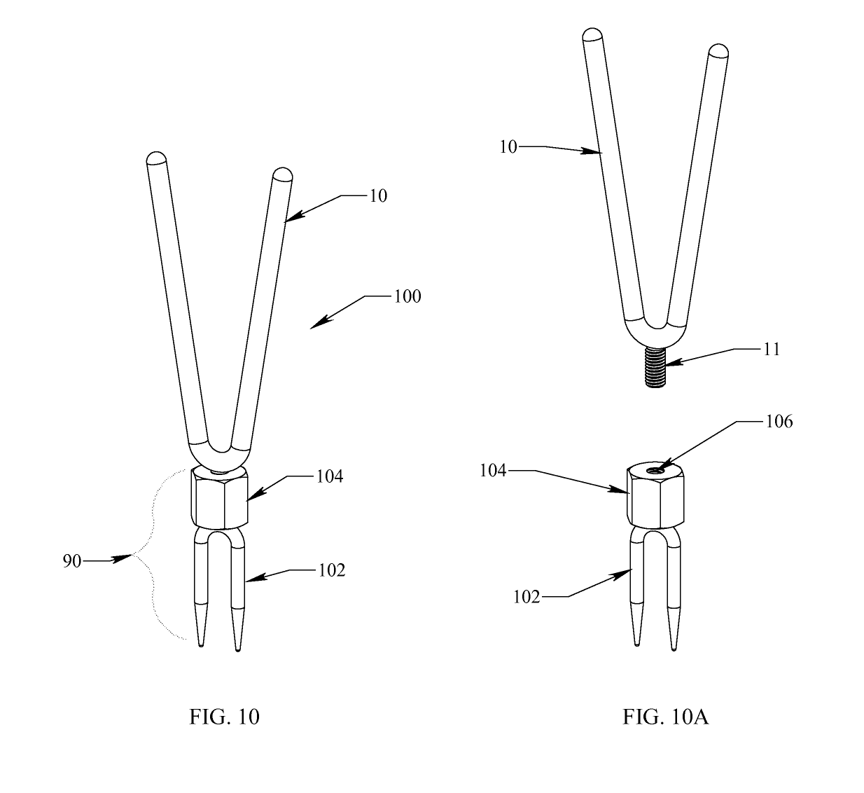

Referring now to FIG. 10 and FIG. 10A, in accordance with one aspect of the present invention, a system 100 is shown with the base system 90 of FIG. 9. The system 100 includes a spike or probe 102 and a base 104. The base 104 defines a bore 106 for receiving the stem 11 of the cradle 10. The spike 102 is secured to the base 104. In accordance with one aspect of the present invention, the probe 102 can be removably attached to the base 104. In accordance with other aspects of the present invention, the probe 102 is permanently secured to the base 104.

In accordance with various aspects of the present invention, removing or separating any base disclosed herein from the cradle 10 is accomplished by turning the cradle 10 in a counterclockwise direction so that the stem 11 moves upwardly, out of the bore or hole of the base, until the cradle 10 is free from the base. It will be apparent that any method of securing the cradle 10 to the base of any system can be utilized. For example, the cradle can engage the base of any system using a tension method, such as pressure fittings.

In accordance with one aspect of the present invention, a threaded stem and threaded bore are used to secure the cradle to the base since this method of attachment will withstand the jarring, vibration and other jolts that the system may experience when attached to a supporting structure, such as a golf cart or during use of the system with larger objects. Nevertheless, other attachment mechanisms, such as clips, tapes, Velcro, etc. are all considered within the scope of the invention.

Thus, with respect to the various aspects of the present invention and the disclosed embodiments, a universal cradle may include an interchangeable attachment kit that would include a plurality of interchangeable bases that modify the function and decoration of the system. FIGS. 2 to 10 show various aspects of the present invention with a cradle attached to various interchangeable bases including a magnetic base, a clamping device to grasp various supporting structures, a single and dual spike to be driven into the ground or any penetrable object, a tabletop stand, a tabletop stand with integrated ash tray, and a base designed to fit within the cup holder of automobiles. The bases described and shown herein are not meant to be an exhaustive list as it is expected that the bases may vary by material, color, texture, design, shape, size, and function.

Reference throughout this specification to “one aspect,” “various aspects,” “an aspect,” or similar language means that a particular feature, structure, or characteristic described in connection with the invention is included in at least one aspect or embodiment of the invention. Thus, appearances of the phrases “in one aspect,” “in various aspects,” “in certain aspects,” and similar language throughout this specification may, but do not necessarily, all refer to the same of the invention.

Unless defined otherwise, all technical and scientific terms used herein have the same meaning as commonly understood by one of ordinary skill in the art to which this invention belongs. Any methods and materials similar or equivalent to those described herein can also be used in the practice or testing of the invention.

It will be apparent to one of ordinary skill that the scope of the present invention is not limited by the type of material used for the cradle or the base as disclosed herein. In accordance with one aspect of the present invention, the stem 11 and the cradle 10 (as well as the systems disclosed herein) may be made of the same material such as steel or another type of heat or fire-resistant material. Furthermore, the color, texture and decorative aspects of the systems may vary.

It can be seen that the invention provides a convenient and economical method for changing the function of a holder based on the user's needs. While particular embodiments of the present invention have been shown and described, those of ordinary skill will appreciate that modifications may be made that fall within the scope and spirit of the invention. In addition, the present invention should not be considered limited to the dimensions of the preferred embodiment described herein.

It is to be understood that this invention is not limited to particular embodiments described, as such may vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof.

Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed is:

1. A system for holding an object, the system comprising:
a base defining a bore therein; and
a cradle including a stem portion,
wherein the stem portion is inserted into the bore of the base to secure the cradle to the base.

2. The system of claim 1 wherein the base is magnetic.

3. The system of claim 1 wherein the base includes a probe.

4. The system of claim 3 wherein the probe is removably secured to the base.

5. The system of claim 3 wherein the probe is permanently secured to the base.

6. The system of claim 1 wherein the base is defined in a shape to fit into a cup holder.

7. The system of claim 1 wherein the base is a clasp.

8. The system of claim 1 wherein the base defines a second bore on the opposite side from the cradle and the second bore receives a dual spike.

9. The system of claim 8 wherein the dual spike is removably secured to the base through the second bore.

10. The system of claim 8 wherein the dual spike is permanently secured to the base through the second bore.

11. The system of claim 1, wherein the base is secured to a vehicle.

12. An apparatus for holding a cigar, the apparatus comprising:
a base defining an opening with an internal thread;
a cradle defined in a v-shape from a rod having tapered ends; and
a stem secured to the cradle, the stem including an external thread that mated to the internal thread of the base, wherein the stem portion is secured to the base to secure the cradle to the base.

13. The apparatus of claim 12 wherein the base is magnetic.

14. The apparatus of claim 12 wherein the base includes a probe.

15. The apparatus of claim 14 wherein the probe is removably attached to the base.

16. The apparatus of claim 12 wherein the base is defined in a shape to fit into a cup holder.

17. The apparatus of claim 12 wherein the base is a clamp.

18. The apparatus of claim 12 wherein the base defines a second bore on the opposite side from the cradle and the second bore defines at least one of a pressure fit hole and a second internal thread and the second bore receives a dual spike including an attachment stem that secures the dual spike to the second bored at the least through one of a pressure fit and a second external thread.

19. The apparatus of claim 18 wherein the dual spike is permanently secured to the base through the second bore.

20. The apparatus of claim 12 wherein the base defines a second bore on the opposite side from the cradle and the second bore receives a dual spike that is removably secured to the base through the second bore.
